(19) United States
(12) Patent Application Publication
(10) Pub. No.: US 2011/0283599 A1
(43) Pub. Date: Nov. 24, 2011

(54) FLYTRAP

(76) Inventors: TSUNG-HSIEN WU, Taipei (TW); Shang-Chia Liu, Taipei (TW); Hung-Yi Chao, Taipei (TW)

(21) Appl. No.: 12/785,481

(22) Filed: May 23, 2010

(51) Int. Cl. A01M 1/04; A01M 1/10

(52) U.S. Cl. 43/113; 43/122

(57) ABSTRACT

A flytrap includes a base, a pyramid, a transparent housing, a light-emitting device and a platform. The platform is for receiving a substance tempting to flies while the pyramid serves to refract and reflect incident ambient light, thereby trapping flies by tempting flies to enter the transparent housing through the pyramid.

### BACKGROUND OF THE INVENTION

1. Technical Field

The present invention relates to flytraps, and more particularly to a flytrap using a pyramid that refracts and reflects light to tempt flies or other insects.

2. Description of Related Art

Flies, being generally attributed as a medium that spreads pathogens and germs, cause hygienic concerns by contaminating human daily food or drinking water. There are some traditional approaches to killing flies. One example is a fly swatter that has a swatting portion for hitting flies. However, its effect is limited because flies fly fast. Another example is a flypaper that uses bait and adhesive to tempt and then trap flies. After occupied by flies trapped by the adhesive, the flypaper is disposed directly. The flypaper is therefore in nature a disposable tool that has to be replaced when its stickiness is lost with time or when it is occupied by flies. However, the frequent renewal means not only higher costs, but also more waste that adversely affects the environment.

### BRIEF SUMMARY OF THE INVENTION

A first objective of the present invention is to provide a flytrap primarily composed of a base, a pyramid, a transparent housing, a light-emitting device and a platform, wherein the pyramid serves to refract and reflect incident ambient light, thereby trapping flies by tempting flies to enter the transparent housing through the pyramid.

A second objective of the present invention is to provide the flytrap wherein the platform below the base is for receiving a substance tempting to flies so as to make flies stop below the pyramid and in turn be led into the transparent housing by glisten of the pyramid that refracts and reflects ambient light.

### BRIEF DESCRIPTION OF THE DRAWINGS

The present invention as well as a preferred mode of use and advantages thereof will be best understood by referring to the following detailed description of an illustrative embodiment in conjunction with the accompanying drawings, wherein:

FIG. 1 is a perspective view of the present invention.

FIG. 2 is an exploded view of the present invention.

FIGS. 3 and 4 are applied views of the present invention.

### DETAILED DESCRIPTION OF THE INVENTION

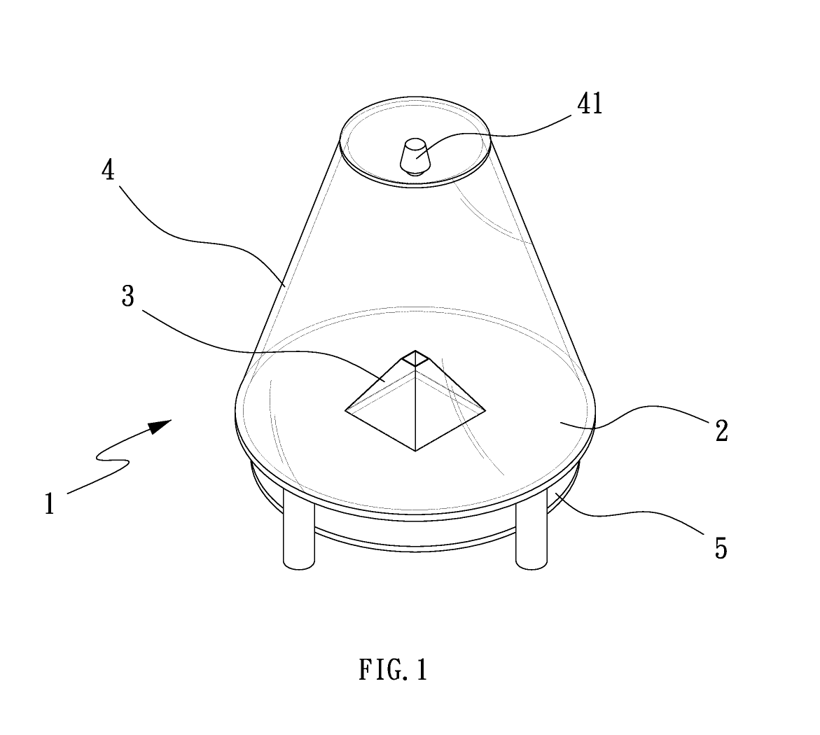

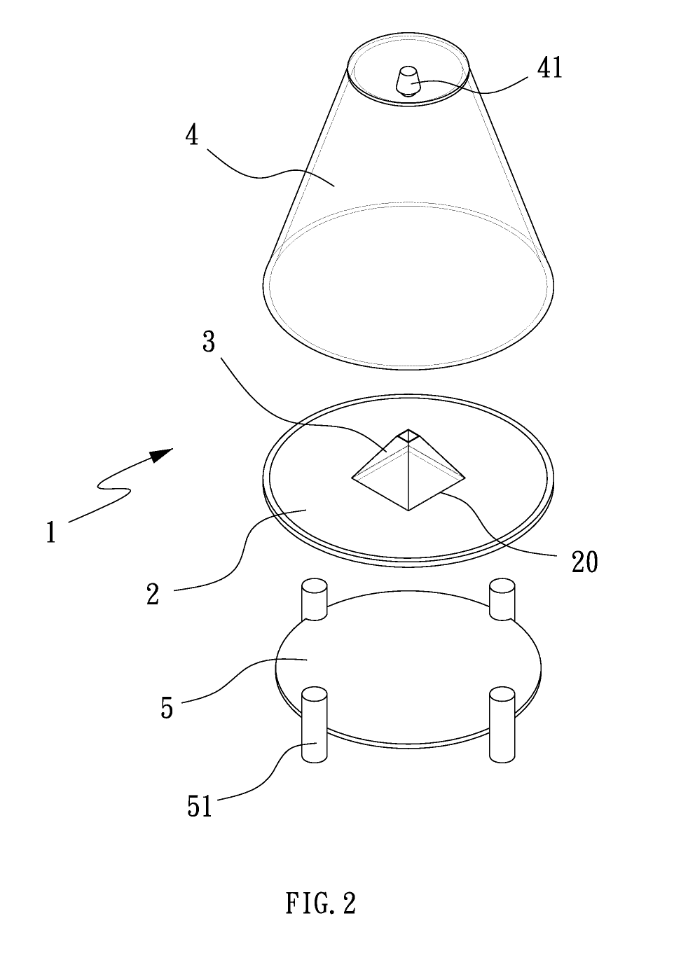

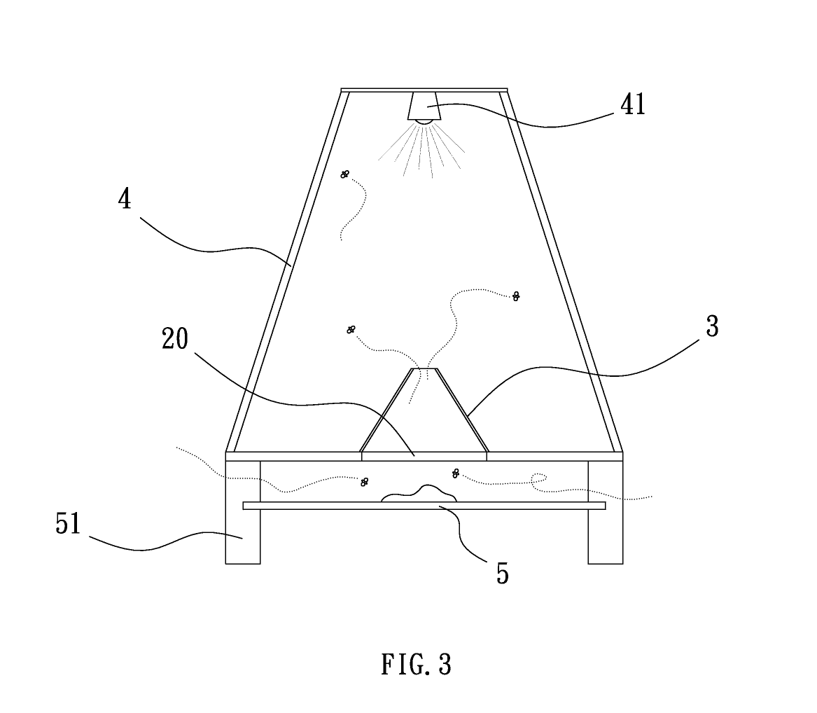

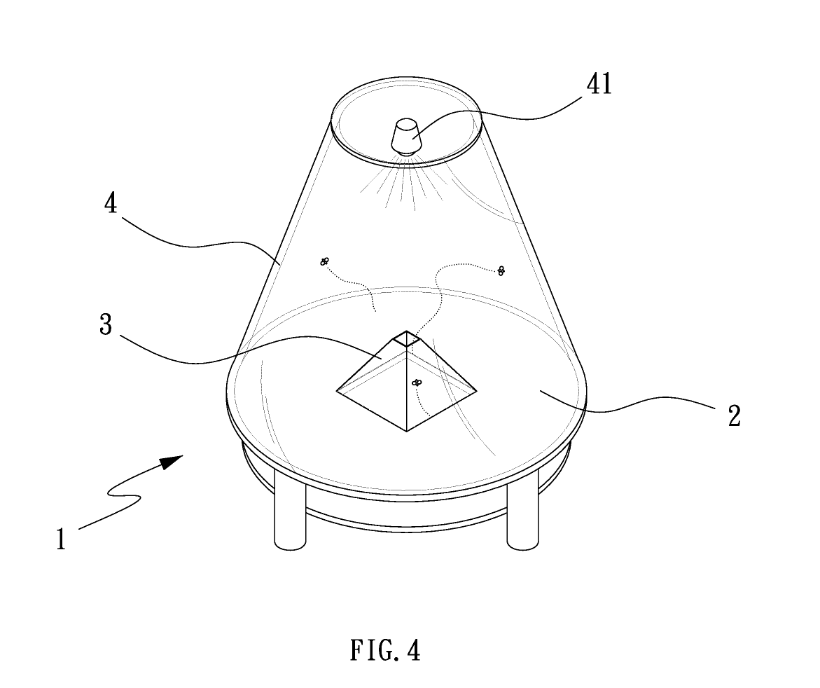

Please first refer to FIG. 1, FIG. 2, FIG. 3 and FIG. 4 for the perspective view, the exploded view and applied views of the present invention.

A flytrap 1 as shown primarily includes: a base 2, a pyramid 3, a transparent housing 4 and a platform 5.

The base 2 is formed with an opening 20.

The pyramid 3 is mounted on the base 2 and corresponding to the opening 20. The pyramid 3 is primarily made of a transparent material and has a hollow structure with upper and lower ends each formed with an opening.

The transparent housing 4 is mounted on the base 2 to cover the pyramid 3.

The light-emitting device 4 is provided atop the transparent housing 4.

The platform 5 is set below the base 2 and is attached thereto a plurality of supporting members 51.

In use of the flytrap 1, a substance tempting to flies has to be placed on the platform 5 below the base 2. Since the pyramid 3 provides plural planes, when ambient light shines on the pyramid 3, the pyramid 3 refracts and reflects the light so as to glisten in multiple directions. Thus, when a fly tempted by the substance such as food or bait stops below the opening 20, the glisten of the pyramid 3 can further lead the fly to enter the transparent housing 4 through the pyramid 3. Since the pyramid 3 has a narrow-end-up axial section, the fly entering the transparent housing 4 is unlikely to escape from the pyramid 3, thus being trapped.

Therein, because flies are born as positively phototoxic, the multi-directional glisten out of the refraction and reflection the pyramid 3 providing to incident light can make flies enter the transparent housing 4 through the pyramid 3. In addition, after the fly enters the pyramid 3 from bottom, since the pyramid 3 has a narrow-end-up axial section, the fly is restricted more as it flies upward, and eventually enters the transparent housing 4. The fly trapped in the transparent housing 4 will be starved due to lack for food.

Moreover, when the flytrap 1 is installed at a relatively dim place where ambient light is not sufficient, a light-emitting device 41 on the transparent housing 4 may be turned on so that light emitted by the light-emitting device 41 can illuminate the pyramid 3, and allows the pyramid 3 to refract and reflect to produce the desired multi-directional glisten and thereby effectively attract and in turn trap flies. Therefore, as compared with the conventional fly swatters or flypapers, the flytrap 1 of the present invention makes use of the nature phototoxic of flies to trap flies, so as to not only significantly improve the efficiency of fly trapping, but also eliminate the need of frequent renewal because of prolonged service life of the flytrap 1.

1. A flytrap comprising:
a base formed with an opening;
a pyramid mounted on the base and corresponding to the opening;
a transparent housing mounted on the base and covering the pyramid;
a light-emitting device provided atop the transparent housing; and
a platform set below the base;
wherein the platform is for receiving a substance tempting to flies.

2. The flytrap of claim 1, wherein the pyramid is made of a transparent material.

3. The flytrap of claim 1, wherein the pyramid has a narrow-end-up axial section.

4. The flytrap of claim 1, wherein the pyramid is hollow and has upper and lower ends each formed with an opening.
